(19) United States
(12) Patent Application Publication
(10) Pub. No.: US 2004/0221176 A1
(43) Pub. Date: Nov. 4, 2004

(54) Methodology, system and computer readable medium for rating computer system vulnerabilities

(76) Inventor: Eric B. Cole, Leesburg, VA (US)

Correspondence Address: TIMOTHY J MARTIN, PC, 9250 W 5TH AVENUE, SUITE 200, LAKEWOOD, CO, 80226, US

(21) Appl. No.: 10/426,908

(22) Filed: Apr. 29, 2003

(51) Int. Cl. H04L 9/00

(52) U.S. Cl. 713/201

(57) ABSTRACT

A computerized method for rating system vulnerabilities comprises assigning a risk rating to each of a plurality of risk categories associated with identified vulnerabilities, whereby each rating has a value indicative of a level of risk for its corresponding risk category. A resultant risk value is then computed for each identified vulnerability based on the risk ratings, thereby indicating a relative overall risk for each vulnerability. A respective waiting factor can also be assigned for each of the risk ratings. A computer readable medium and a vulnerability rating system for use in assessing computer system vulnerabilities are also provided.

### FIELD OF THE INVENTION

The present invention broadly relates to the field of rating schema, and more particularly concerns methodologies, systems and computer-readable media for use in rating vulnerabilities associated with computer systems.

### BACKGROUND OF THE INVENTION

Many, if not most, computer systems in use today are susceptible to a wide range of vulnerabilities. This is primarily based on the fact that computer systems are typically connected, either directly or indirectly, to the global internet which increases their susceptibility to hacking, viruses and the like. Once a computer system has been successfully infiltrated an attacker can make unauthorized use of the computer's resources or interfere with the intended use of those resources, among other things.

It can therefore be in the interest, particularly for companies, to implement security assessment procedures to ascertain the potential vulnerabilities associated with either stand alone computer systems or networked computer systems. Many companies, in fact, perform such assessments but struggle with the dilemma of dealing with all of the identified vulnerabilities in an efficient manner. Ideally, for cost benefit reasons, a company would like to focus on the most important vulnerabilities for its particular computer system environment. To this end, robust vulnerability rating schemes for computer systems are needed for identifying and prioritizing potential vulnerabilities so that appropriate prevention techniques can be implemented. Unfortunately, many companies only have a limited amount of resources to devote to fixing security on their systems. Therefore, an accurate classification of which vulnerabilities are the most important to be addressed can help companies allocate their budgets in a reasonable fashion. At the same time, attendant with the ever-changing environments in which computer systems operate, is the need for vulnerability rating schemes to be flexible to account for differing interests and differing environments.

Depending on one's definition of what constitutes a “vulnerability”, the term could encompass any of a variety of potential susceptibilities to a computer system. Such susceptibilities might include, for example only, the ability of a machine to be port scanned through a firewall, the tampering with default permissions on directories, registry settings, or log settings, the ability to circumvent password protection mechanisms, or any other type of misconfiguration of a system. When a system's “vulnerability” is viewed broadly, it is not difficult to see that most computer systems have some vulnerabilities of one form or another. In fact, it is not uncommon for the default installation of many operating systems to have a large number of inherent vulnerabilities. Because of these facts, it can be crucial for a company not only to identify what potential vulnerabilities exist, but to be able to effectively rate them according to risk. Except in extreme circumstances, however, it is unlikely that a company will ever remove all vulnerabilities from its computer system(s). Some might argue that this is actually impossible to do for any machine that is connected to a network, such as the global internet. Nonetheless, it is still desirable to minimize to the extent practical the threats to computer systems in an effort to mitigate against infiltration by any authorized means.

One type of known vulnerability classification scheme is described in “Internet Systems Security (ISS), Xforce database” and utilizes a high, medium or low rating for each identified vulnerability. There can be various drawbacks to such a rating system. For example, resultant vulnerability ratings can be undesirably skewed based on an individual's subjective determinations and conflicting objectives among raters. Furthermore, disparities among individual ratings given, for example by security professionals, can be exacerbated when rudimentary schemes are employed having only a small number of choices over a single-tier rating scale. In addition, with only a few choices to select from (low, medium and high) it can be appreciated that errors in calculation can have a large impact on where a particular vulnerability is prioritized compared to others.

Another type of known vulnerability classification, such as that discussed in “Hacking Exposed”, by McClure, Scambray and Kurtz, Osborne/McGraw-Hill 1999 employs a three part scheme which assesses popularity, simplicity and impact of the vulnerability by rating each characteristic on a numerical scale between 1 and 10. Such an approach also has inherent limitations by virtue, not only of the number of categories addressed, but how different raters might numerically distinguish how a particular category should be rated. Still other types of known vulnerability rating schemes, such as described in the unclassified DOD publication “Department of Defense Trusted Computer System Evaluation Criteria, December 1985, DOD 5200.28-STD.hml”, tend to focus more on particular types of security issues, such as intrusion detection systems, rather than system-wide vulnerabilities.

Thus, while existing vulnerability rating systems can be useful in certain circumstances, they are often one dimensional, lack versatility and expandability, and the reliability of their results is prone to fluctuate based on various factors, such as those discussed above. Accordingly, there remains a need to provide an improved scheme for rating computer system vulnerabilities which is more reliable and versatile, and more readily adapted to differing and changing computer system environments. The present invention is particularly directed to meeting these needs.

### SUMMARY OF THE INVENTION

Another object of the present invention is to provide a computerized method for use in rating computer system vulnerabilities.

It is an object of the invention to provide a new and improved computerized method for rating computer system vulnerabilities.

A further object of the present invention is to provide a computer readable medium having computer executable instructions for performing such a vulnerability rating method.

Still another object of the present invention is to provide a vulnerability rating system for assessing vulnerabilities associated with a selected computer system environment.

Yet a further object of the present invention is to provide such a method, medium and system which is readily adaptable for rating vulnerabilities associated with different computer system environments, while at the same time being selectively re-configurable as the computer system environment changes.

In accordance with these objectives, the present invention in one sense relates to a computerized method for use in rating computer system vulnerabilities. Broadly, and with respect to each vulnerability which has been identified, this computerized method comprises assigning a risk rating to each of a plurality of risk categories associated with the identified vulnerability, thereby to generate a plurality of risk ratings each having a value indicative of a level of risk for its corresponding risk category. The broad method additionally entails computing a resultant risk value for the identified vulnerability based on the risk ratings, thereby to indicate a relative overall risk for the vulnerability. According to another embodiment of this methodology, a plurality of computer system vulnerabilities associated with a selected computer system environment are identified. A plurality of risk categories are associated with each identified vulnerability and a risk level set is associated with each identified risk category. For each identified vulnerability, the risk rating is assigned for each associated risk category and a resultant value is computed based on the assigned risk ratings, thereby to generate a set of resultant risk values each indicative of a relative overall risk for the identified vulnerability. Then, a prioritized listing for the computer system's vulnerabilities is created from this set of resultant risk values.

For either of the above methodologies, each risk value is preferably an integer within a range of 1 and 5, inclusively. Further, for a given computer system environment, it is also preferred that the risk categories for its associated vulnerabilities be the same. A first one of these risk categories preferably corresponds to a level of resulting compromise to the computer system which could occur upon exploitation of the identified vulnerability. A second one of the risk categories preferably corresponds to a level of access to the computer system needed in order to exploit the identified vulnerability. A third one of the risk categories preferably corresponds to a degree of impact to the computer system which could occur upon exploitation of the identified vulnerability. A fourth one of the risk categories preferably corresponds to an availability of tools which could be employed to exploit the identified vulnerability. A fifth one of the risk categories preferably corresponds to a level of experience required in order to exploit the vulnerability, and a sixth one of the risk categories preferably corresponds to an availability of countermeasures for preventing exploitation of the vulnerability. When such risk categories, referred to respectively as C₁-C₆, are utilized, each resultant risk value (RV) is calculated according to the formula:

{(I(C₁)+I(C₂)+I(C₃)+I(C₄)+I(C₅)/I(C₆)}

where I(C) corresponds to the risk value integer assigned to. If desired, a weighting factor can also be assigned to each of the risk ratings, thereby to define a set of weighting factors WF₁-WFₙ, where “n” corresponds to the total number of risk categories. When weighting factors are employed, the resultant risk value (RV) can be calculated according to the formula:

[(WF₁×C₁)+(WF₂×C₂+(WF₃×C₃)+(WF₄×C₄)+(WF₅×C₅)]/(WF₆×C₆).

A computer readable medium is also provided according to the present invention. The computer medium has computer executable instructions for performing a method corresponding to the second exemplary embodiment of the methodology discussed above. Finally, the present invention also encompasses a vulnerability rating system for assessing vulnerabilities. A first embodiment of the vulnerability rating system comprises a storage device, an output device and a processor. The processor is programmed to assign a risk rating to each of a plurality of risk categories associated with each of a plurality of identified computer system vulnerabilities. The processor is further programmed to generate a set of resultant risk values for the computer system by computing a resultant risk value for each identified vulnerability, and to arrange the set of resultant risk values into a prioritized listing that is stored on the storage device. Finally, the processor is programmed to control the output device to display output corresponding to the prioritized listing. Another embodiment of the vulnerability rating system is adapted for assessing vulnerabilities associated with a plurality of selected computer system environments. This system embodiment comprises storage means, input means, output means and processing means. The processing means is for identifying a plurality computer system vulnerabilities associated with each of a plurality of different computer system environments thereby to define associated sets of vulnerabilities. The processing means causes the associated sets of vulnerabilities to be stored on the storage means. With respect to each of the computer system environments, and for each set of vulnerabilities associated therewith, the processing means receives input from the input means corresponding to a risk rating being assigned for each of the risk categories, and operates to compute a resultant risk value based on the input, as discussed above, so that a vulnerability listing can be created having a selected organization based on the set of resultant risk values.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 illustrates a diagram of an exemplary general purpose computer that may be used in implementing the aspects of the present invention;

FIG. 2 represents a high level flowchart for computer software which implements the functions of the vulnerability rating system of the present invention;

FIG. 3 is a diagrammatic view which illustrates the association among risk level sets and their associated risk categories for a representative identified vulnerability; and

FIG. 4(a) shows a representative dialog window to illustrate one possible graphical user interface (GUI) for the application program of the present invention, and specifically illustrates how the resultant risk value for an identified vulnerability can be obtained; and

FIG. 4(b) illustrates how the resultant risk value can be obtained for the identified vulnerability in FIG. 4(a) when weighting factors are assigned to each risk category.

### DETAILED DESCRIPTION OF THE EXEMPLARY EMBODIMENTS

The present invention provides a flexible system for rating computer system vulnerabilities which is adaptable to changing environmental conditions and which provides a reduced chance of error among various raters. Rather than rating vulnerability on a single scale, such as low, medium or high, as done in the prior art, there are multiple categories that are rated according to the present invention. Each category also has several pre-defined items, referred to as risk factors, to choose from. Since, in the preferred implementation of the present invention, there are multiple risk categories and multiple risk factors associated with each category, the error introduced in an overall risk rating is minimalized when discrepancies occur among raters.

For purposes of the present invention, computer system “vulnerabilities” are broadly construed to be weaknesses in a system that allow an attacker to illegitimately gain information or access, gain increased privileges, deny the use of the system, impersonate the identity of some legitimate user, or help hide the detection of an attack. The term “attacker” refers to any unauthorized user of the system or anyone that is using access in a way that it was not intended to be used. This second part is important because some might regard an authorized user of the system, who illegitimately uses system resources, as not unauthorized; however, such a person is considered to be an “attacker” for purposes of the present invention. Accordingly, the terms “vulnerabilities” and the term “attacker”, as used throughout the description to follow, should be regarded in the broadest sense possible according to the purposes of the present invention.

In its preferred form, the present invention is implemented on a user's computer system which typically includes an input device such as a keyboard, a display device such as a monitor, and a pointing device such as a mouse. The computer also typically comprises a random access memory (RAM), a read only memory (ROM) a central processing unit (CPU), and a storage device. The storage device may be a large-capacity permanent storage such as a hard disk drive, or a removable storage device, such as a floppy disk drive, a CD-ROM drive, a DVD-ROM drive, flash memory, a magnetic tape medium, or the like. However, the present invention should not be unduly limited as to the type of computer on which it runs, and it should be readily understood that the present invention indeed contemplates use in conjunction with any appropriate information processing device, such as a general-purpose PC, a PDA or the like. Moreover, the computer-readable medium which contains executable instructions for performing the methodology discussed herein can be a variety of different types of computer-readable media, such as the removable storage devices noted above, whereby that the user's application software can be stored in an executable form on the computer system.

The source code for the software was developed on a Windows machine utilizing Microsoft's Visual C++. NET with Microsoft Foundation Class (MFC) library, which includes its own compiler for converting the high level C++ programming language into machine code. However, the software program could be readily adapted for use with other types of operating systems, such as Unix or DOS, to name only a few, and it may be written in one of several widely available programming languages with the modules coded as sub-routines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventor should not be interpreted to limit the environment of the present invention. The software embodying the present invention may be distributed in known manners, such as on computer-readable medium or over an appropriate communications interface so that it can be installed on the user's computer system. Furthermore, alternate embodiments of the invention which implement the system in hardware, firmware or a combination of both hardware and software, as well as distributing the modules and/or the data in a different fashion, will be apparent to those skilled in the art. It should, thus, be understood that the description to follow is intended to be illustrative and not restrictive, and that many other embodiments will be apparent to those of skill in the art upon reviewing the description.

In the following detailed description, reference is made to the accompanying drawings which form a part hereof, and in which is shown by way of illustrations specific embodiments for practicing the invention. The leading digit(s) of the reference numbers in the figures usually correlate to the figure number, with the exception that identical components which appear in multiple figures are identified by the same reference numbers. The embodiments illustrated by the figures are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the appended claims.

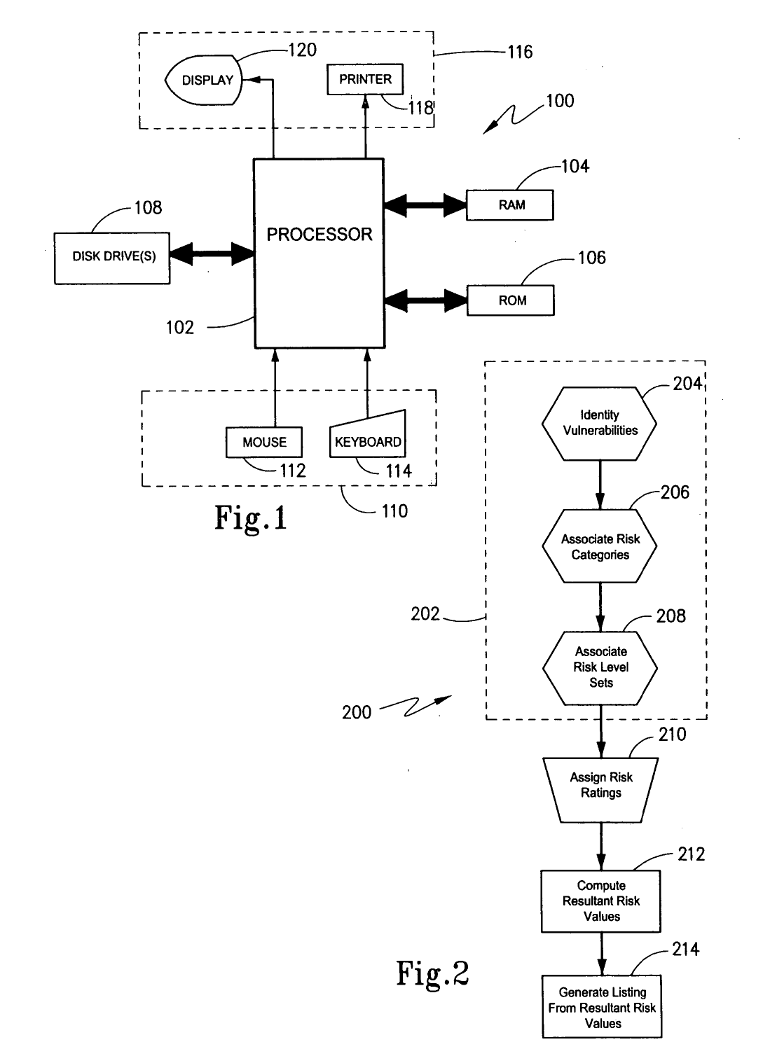

With the above in mind, initial reference is made to FIG. 1 which diagrammatically illustrates a general purpose computer 100 that may be used to execute applications for rating computer system vulnerabilities in accordance with the present invention. General purpose computer 100 may be adapted to execute in any of the well-known operating system environments, such as MS-DOS, PC-DOS, OS2, UNIX, MAC-DOS and Windows, or other operating systems. General purpose computer 100 comprises a processor 102, random access memory (RAM) 104, read only memory (ROM) 106, disk drive(s) 108, one or more input devices 110 such as mouse 112 or keyboard 114, and one or more output devices 116, such as a printer 118 or a monitor/display l20. Disk drive(s) 108 may include one or more of a variety of types of storage media, such as, for example, floppy disk drives, hard disk drives, CD ROM drives, CD-RW drives, DVD drives, or magnetic tape drives, without limitation. The present invention encompasses a program that may be stored in a appropriate computer-readable medium, such as RAM, ROM, a disk drive, or the like and which is executable by processor 102, thereby to form a vulnerability rating system.

While the general purpose computer 100 illustrated in FIG. 1 is shown as a stand-alone system, it could also be connected to a computer network through a telephone line, an antenna, a gateway, or any other type of communication link. Accordingly, FIG. 1 only illustrates one example of a computer that may be used with the present invention, and it should be recognized the invention could be adapted for use on computers other than general purpose computers, as well as on general purpose computers without conventional operating systems.

In FIG. 2, a high level flowchart is shown for computer software which implements the functions of the vulnerability rating system of the present invention. It should be appreciated that FIG. 2 illustrates the broad aspects of the computerized methodology as it relates to a selected computer system environment. These broad aspects, however, could be readily adapted for other computer system environments, or updated as a given computer system environment changes over time.

According to methodology 200, preliminary steps 202 are taken whereby vulnerabilities are identified at 204 for the selected environment, which may be a financial institution, a law firm, an ISP provider, etc. Risk categories are associated with the vulnerabilities at 206 and a risk level set is associated with each risk category at 208. Once this information is collected it can be stored in a database on the computer system and updated, altered or otherwise manipulated as desired. That is, vulnerabilities for the particular computer system environment can be added to the listing as they become known, or vulnerabilities can be removed from the listing if, for whatever reason, they are no longer applicable to the environment. Similarly, the risk categories associated with each identified vulnerability and their associated risk level sets can also be tailored according to a user's preferences. In any event, in order to rate the identified vulnerabilities at 210 in FIG. 2, a risk rating is assigned to each category, and resultant risk value is then computed at 212 based on the risk ratings. A prioritized listing can then be generated at 214 from these resultant risk values.

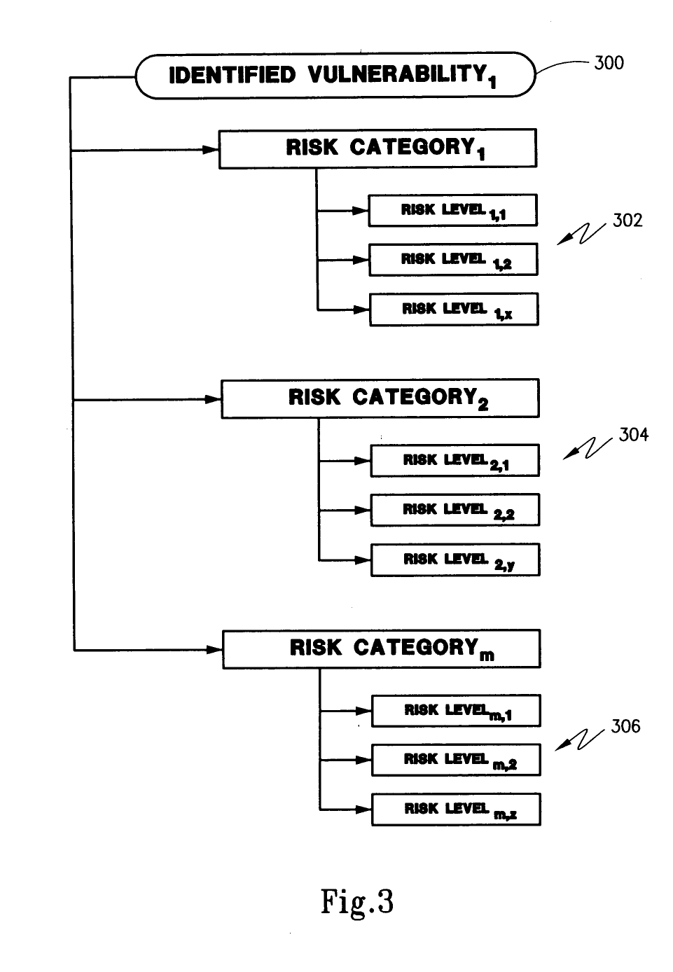

FIG. 3 shows the relationships between the risk categories and the risk levels for a given identified vulnerability 300. There can be numerous interpretations as to what constitutes a “risk” to a computer system. Accordingly, it can be difficult to define what is meant by risk, or to even get a general consensus on an approximate definition. To complicate matters, a given vulnerability to a computer system may have a higher risk associated with it in one environment then it might in another. For example, one of the highest priorities of a credit card company is to secure their list of credit card numbers from unauthorized access. For different reasons, an internet portal site may find the danger associated with denial of service to be a greater threat. This leads to the conclusion that it may be difficult to arrive at a single definition for the word “risk”. In light of this, the present invention preferably associates a plurality of risk categories, identified in FIG. 3 as Risk Category₁, Risk Category₂ . . . Risk Category ₘ, for each identified vulnerability. In the preferred embodiment of the invention there are six such risk categories and these risk categories remain the same, regardless of the identified vulnerability. These six risk categories are identified in the following table; however, the particular descriptive terminology employed to describe the respective categories are for explanatory purposes only and should not be construed as unduly limited the scope of the invention.

| | |
|---|---|
| Risk Category₁ (C₁) | Level of Resulting Compromise |
| Risk Category₂ (C₂) | Level of Access |
| Risk Category₃ (C₃) | Systems Impacted |
| Risk Category₄ (C₄) | Availability of Tools |
| Risk Category₅ (C₅) | Ease of Performing the Exploit |
| Risk Category₆ (C₆) | Countermeasures |

The “level of resulting compromise” risk category is intended to be an indication of the extent of damage or compromise that could occur if an attack against a computer system using the particular vulnerability is successful. This category focuses on the type of access someone would gain using a particular exploit or the amount of damage that could be caused. The “level of access” risk category indicates the type of access to a computer system that an attacker must have in order to successfully carry out (i.e. exploit) the vulnerability. The “systems impacted” risk category looks at how bad or widespread the vulnerability is. In other words, it focuses on whether a given vulnerability impacts a small number of systems or the entire Internet. It also looks at whether the vulnerability impacts a specific application or a wide range of operating systems. The “availability of tools” risk category is intended to address the availability of tools for allowing a attacker to carry out the exploit of a computer system. This is, in some sense, a measure of popularity in the hacking community. Sometimes, it is safe to assume that the more popular an exploit is, the more likelihood there exists an executable for running the exploit against a system. The fifth risk category, “ease of performing the exploit”, indicates the relative ease with which an attacker may carry out an exploit, by focusing on the level of knowledge and expertise that an attacker must possess. The final risk category, “countermeasures”, concentrates on what capabilities are available, and which can be applied to a computer system, to prevent or defeat the exploit of a particular vulnerability so that the system is no longer susceptible to attack.

With reference again to FIG. 3, it can be seen that there is a risk level set associated with each risk category, such as those identified above. That is, a first Risk Level Set 302 is associated with Risk Category₁ and includes Risk Level_{1,1} . . . Risk Level_{1,x}. Similarly, second Risk Level Set 304 associated with Risk Category₂ includes Risk Level_{2,1} . . . Risk Level_{2,y}. Finally, Risk Level Set 306 associated with Risk Categoryₘ includes Risk Level_{m,1} . . . Risk Level_{m,z}.

With reference again to the preferred embodiment of the present invention, the risk level set associated with the “level of compromise” risk category is subdivided into the following risk level:

| | |
|---|---|
| Risk Level_{1,1} | System Information Disclosed |
| Risk Level_{1,2} | Gain Low-Level Access |
| Risk Level_{1,3} | Denial of Service Access |
| Risk Level_{1,4} | Gain Additional Privileges |
| Risk Level_{1,5} | Possible Administrative Access |

As with noted above with respect to the six risk categories, particular descriptive terminology employed to describe the respective risk levels within each category are for explanatory purposes only and should not be construed as unduly limited the scope of the invention. With this in mind, Risk Level_{1,1} addresses whether the attacker is able to obtain information about the computer system, such as the version of the operating system, which processes and services are running, and which users are currently logged on. This includes data files or information that could not lead to gaining access, but which provide information about the company, for example. At Risk Level_{1,2}, exploitation of the vulnerability permits an attacker to gain ordinary user access and perform any activity allowed by the rights associated with the user. This would include access to information that could easily lead to user access. A Risk Level_{1,3}, the exploit causes the system to deny access to legitimate users. This can either be done by flooding a machine or actually crashing a machine so that it can no longer respond to legitimate users. Risk Level_{1,4} particularly addresses an NT environment where there are several levels of access one can gain that range from user access to domain administrator access. Accordingly, risk level_{1,4} deals with anything that enables an attacker to get a level of access other than normal user or domain administrator access. Finally, at Risk Level_{1,5} exploitation of the vulnerability would allow an attacker to gain administrative access to the system. This includes exploits that give an attacker information that could easily lead to this level of access. It is important to note that if a particular exploit could lead to various levels of access, the highest possible access gets assigned. For example, if one could export the password file on an NT domain, it should obtain a rating of possible administration access since the chance of getting this level of access are almost guaranteed.

With respect to the level of access risk category (C₂) discussed above, there are three associated risk levels which have been identified as follows:

| | |
|---|---|
| Risk Level_{2,1} | Physical Access |
| Risk Level_{2,2} | Domain/LAN Access |
| Risk Level_{2,3} | Remote/Internet Access |

Risk Level_{2,1} means that the attacker is able to physically lay his/her hands on a machine to carry out the exploit. A basic example of this type of attack would be the physical theft of the machine. Associated Risk Level_{2,2} means that the attacker must be considered a legitimate member of the domain, either by explicit membership, such as through a trust relationship or by a previous vulnerability that was exploited. Under this level, the user does not necessarily have to be a member of the domain but either the user or the machine has to be a member of the domain. This is a minor but important distinction. For example, if an attacker does not have a valid user ID, but can nonetheless access a facility because it is unrestricted, the attacker could sit down at an unlocked terminal to run an exploit. In such a case, the attacker doesn't actually know which account he/she is logged on with, but has a machine that is a member of the current domain. Finally, at associated Risk Level_{2,3}, the attacker may be anyone not considered part of the domain. One way to look at this any machine on the internet running TCP/IP. A somewhat different way to look at it is any situation in which the attacker cannot be viewed as somebody fitting within Risk Level_{2,1} or Risk Level _{2,2}.

As for the third Risk Category (C₃) which corresponds to the “systems impacted”, the following associated risk levels are preferably employed:

| | |
|---|---|
| Risk Level_{3,1} | Impacts a Single Application |
| Risk Level_{3,2} | Impacts Most Applications |
| Risk Level_{3,3} | Impacts a Single Operating System |
| Risk Level_{3,4} | Impacts Most Operating Systems |

Risk Level_{3,1} applies if only a single vendor's application is vulnerable. An example of such a situation would be an application produced by a vendor having a vulnerability that is only present in their system and not in any competing product. Risk Level_{3,2} applies if the vulnerability impacts several applications that all perform a similar function. For example, a common gateway interface (cgi) exploit would impact most vendors' web servers and therefore would fit under this level. Risk Level_{3,3} applies if the vulnerability impacts only a single vendor's operating system and not that of others. Finally, Risk Level_{3,4} applies if the vulnerability impacts a large number of operating systems across various vendors. For example, a vulnerability that impacts Microsoft, Unix and Cisco Equipment would be covered under this level.

As for the fourth Risk Category (C₄) which corresponds to the availability of tools, the following risk levels have been identified:

| | |
|---|---|
| Risk Level_{4,1} | No Tools |
| Risk Level_{4,2} | Description of Exploit Algorithms |
| Risk Level_{4,3} | Source Code Available |
| Risk Level_{4,4} | Executable Available |

Risk Level_{4,1} applies if no tools or other information is available to assist the attacker in exploiting the vulnerability. Associated Risk Level_{4,2} applies if instructions for carrying out the exploit exist, but there is no automated support or source code available. Risk Level_{4,3} applies if the attacker must possess the skill to compile the source code and invoke the resulting executable to carry out an attack. This is more common on Unix operating systems. A general rule of thumb is that, with Unix, an attacker gets source code, while an attacker gets an executable with NT. Finally, associated Risk Level_{4,4} applies if an executable file exists that allows an attacker to run the exploit with minimal effort or intervention. This level would also apply if no executable is even needed to run the exploit. For example, with the “ping of death” attack, technically there were no executables available for this exploit. However, since it was so trivial to run, only the ping executable program was needed.

The following associated risk levels are preferable used in connection with the “ease of performing the exploit” Risk Category (C5).:

| | |
|---|---|
| Risk Level_{5,1} | High Degree of Expertise |
| Risk Level_{5,2} | Some Expertise |
| Risk Level_{5,3} | Script Kiddie |
| Risk Level_{5,4} | Minimum Knowledge |

Risk Level_{5,1} contemplates that the attacker must understand the details of the operating system and various communication protocols, and be able to write programs that are capable of exploiting the vulnerability (e.g. IP spoofing, man-in-the-middle attack, etc.). Under Risk Level_{5,2}, the attacker must understand how pre-compiled executables work to carry out the attack. Further, the attacker must also possess some knowledge of programming. This is typically someone who either knows the operating system or the communication protocols very well, but not both. Associated Risk Level_{5,3} applies if the attacker must only possess knowledge of how to use some of the basic troubleshooting and hacking tools that are readily available in order to carry out the exploit. Here, the attacker generally understands exploits from a high level and can manually carry out certain basic exploits by hand, such as in the case of an exploit which involves using telnet to connect to a specific port in order to issue commands. Finally, according to Risk Level_{5,4}, the attacker has a general working knowledge of the system, but from an expertise level can do nothing more than run executables.

Finally, as for the sixth Risk Category (C₆) corresponding to “counter measures”, the following risk levels are preferably employed:

| | |
|---|---|
| Risk Level_{6,1} | No Fix |
| Risk Level_{6,2} | Manual Configuration |
| Risk Level_{6,3} | Fix Available from Vendor |
| Risk Level_{6,4} | Fix Available in the Latest Version |

Under Risk Level_{6,1}, there is no known fix associated with the vulnerability, or the only fix known is to disable or remove the service/component associated with the vulnerability (e.g. ftp, finger, etc.). In some cases the only way to fix a certain vulnerability is to remove that service or close that port. The present invention treats that as being equivalent to not having a fix. Associated Risk Level_{6,2} applies if no service patch or interim fix is available, but the vulnerability of the machine can be fixed by manually configuring the system. Associated Risk Level_{6,3} applies if the operating system vendor has identified the fault that permits a particular exploit, has taken corrective measures, and has issued a corrective service patch for that particular vulnerability, but the service patch has not been installed on the computer system. Finally, Risk Level_{6,4} means that the operating system vendor has identified the fault, and the latest version of the operating system or application includes a fix for the vulnerability. With operating systems like NT, the vendor does not issue new versions but issues service packs, that would be covered under this level.

Having described the preferred categorization of risks, and the associated risk levels pertinent thereto, a user's ability to rate an identified vulnerability can now be better appreciated. That is, for each identified vulnerability, a rater assigns a risk rating to each category, wherein the risk rating is determined by which of the associated risk levels from the risk factor set best applies for the particular risk category. Since, from the description above, it can be appreciated that the associated risk levels for each of the categories are organized based on the severity, a numerical integer (I) can be assigned to each such risk level. That is, the lowest risk level is assigned the integer “1”, the second lowest is assigned the integer “2” and so on. Once a rater has selected the appropriate risk level associated with each of the risk categories, a resultant risk value (RV) is computed for the identified vulnerability based on the risk ratings. The resultant risk value (RV) is calculated as follows:

RV={(I(C₁)+I(C₂)+I(C₃)+I(C₄)+I(C₅)/I(C₆)}

It can be appreciated that, when the above is calculated for each of plurality of identified vulnerabilities associated with a selected computer system environment, each risk value (RV) indicates a relative overall risk for the associated vulnerability so that a person or company one can create a prioritized vulnerability listing based on the set of computed resultant risk values.

In addition to the above, a respective weighting factor (WF) can also be assigned to each of the risk categories if desired. This can be useful, for example, if circumstances change which make it important to have the overall risk value for an identified vulnerability impacted more or less by the various categories. In such a situation, the overall risk value is determined by the following formula:

$$RV = \frac{\begin{matrix}{WF}_{1} \times I ( {C}_{1} ) + {WF}_{2} \times I ( {C}_{2} ) + \\ {WF}_{3} \times I ( {C}_{3} ) + {WF}_{4} \times I ( {C}_{4} ) + {WF}_{5} \times I ( {C}_{5} )\end{matrix}}{( {WF}_{6} \times I ( {C}_{6} )}$$

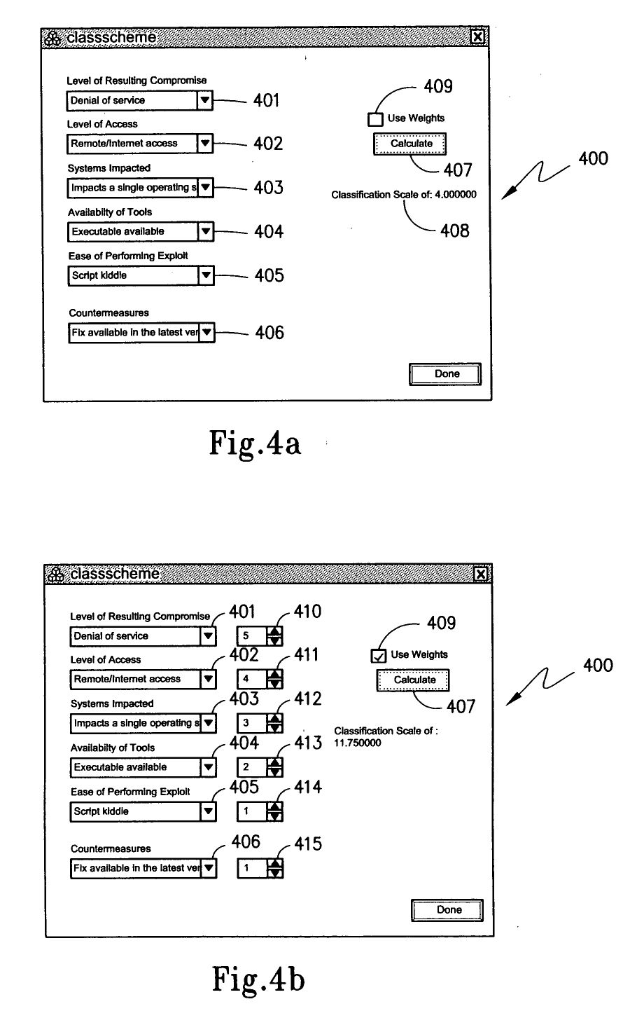

With an appreciation of the above, reference is now made to FIGS. 4(a) and 4(b), to illustrate, through a graphical user interface (GUI) how a given identified vulnerability can be rated. FIG. 4(a) illustrates the computation of an overall risk rating for an identified vulnerability when weighting factors are not employed, while FIG. 4(b) illustrates a computation which does employ weighting factors. In each of FIGS. 4(a) and 4(b) an application's dialog window 400 is shown having a plurality of list boxes 401-406, each corresponding to the six risk categories (C₁-C₆) discussed above. The drop down list boxes enable a user to select, for each of the risk categories, the most appropriate risk level from the associated risk level sets discussed above. As a representative example only, FIGS. 4(a) and 4(b) illustrate a calculation which might be obtained when one is concerned about rating the well-known “WinNuke” vulnerability. Since “WinNuke” is a denial of service exploit for Windows machines, the most appropriate risk level under the “level of resulting compromise” risk category is “denial of service” which is assigned the integer 3. As for the “level of access” category, the most appropriate risk level is “remote/internet access” (also assigned the integer 3) since the “WinNuke” attack can be run from any machine on the internet, such that local or domain access is not required. Since the “WinNuke” attack only impacts Microsoft operating systems by taking advantage of a weakness in a Net BIOS port, the most appropriate risk level under the “systems impacted” category is that it “impacts a single operating system”, also assigned the integer 3. As for the fourth risk category, “availability of tools”, the most appropriate risk level is number 4 since there are several executables available on the internet that would allow someone to run this attack. “Script Kiddie” is the most appropriate risk level for the fifth category “ease of performing exploit” because “WinNuke” is a fairly straightforward attack which allows someone to send out of band data to a victim's machine. This requires some knowledge of the internet but not a high level. Finally, since Microsoft has released a service pack that fixes the problem, and since service packs are treated as the latest version with Microsoft operating systems, the most appropriate countermeasure is also identified, which corresponds to the integer 4. Having made appropriate selections as shown in FIG. 4(a) the user can then enable the calculation button 407 to generate the resultant value score of 4.0. Alternatively, as shown in FIG. 4(b), upon selection of check box 409, the user can assign respective weighting factors 410-415 to each of the risk categories as shown. This generates a resultant value calculation score of 11.75 for the “Win Nuke” vulnerability.

It can be appreciated, then, that the same process can be repeated for each of plurality of identified vulnerabilities associated with one or more computer system environments, with the program preferably generating a prioritized listing of the vulnerabilities based on the set of resultant risk values. This would, then, enable an individual or company to identify those vulnerabilities which are worth addressing before others. Conveniently, a windows-based programming environment could be created to have a dialog box, such as shown in FIGS. 4(a) and 4(b) appear each time a user desires to calculate a resultant value for a selected identified vulnerability. Further, the programming environment could be tailored to have a main application window which presents to the user the set of identified vulnerabilities, while allowing the user to modify the set through known editing techniques.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A computerized method for use in rating computer system vulnerabilities comprising, with respect to each identified vulnerability:
assigning a risk rating to each of a plurality of risk categories associated with the identified vulnerability, thereby to generate a plurality of risk ratings, each having a risk value indicative of a level of risk for its corresponding risk category; and
computing a resultant risk value for the identified vulnerability based on the risk ratings, thereby to indicate a relative overall risk for the identified vulnerability.

2. A computerized method according to claim 1 wherein each risk rating has a numerical risk value within a selected numerical range.

3. A computerized method according to claim 2 wherein said numerical range is an integer between 1 and 5, inclusively.

4. A computerized method according to claim 1 wherein the risk categories associated with each vulnerability are the same.

5. A computerized method according to claim 1 including prioritizing the computer system vulnerabilities after each resultant risk value has been computed.

6. A computerized method for rating computer system vulnerabilities, comprising:
identifying a plurality of computer system vulnerabilities associated with a selected computer system environment;
associating a plurality of risk categories for each identified vulnerability;
associating a risk level set for each identified risk category;
with respect to each identified vulnerability:
assigning a risk rating for each risk category associated with the identified vulnerability, each said risk rating having an associated risk value indicative of a level of risk for its corresponding risk category; and
computing a resultant risk value based on the assigned risk ratings, thereby to generate a set of resultant risk values each indicative of a relative overall risk for the identified vulnerability; and
creating a prioritized listing of computer system vulnerabilities from the set of resultant risk values.

7. A computerized method according to claim 6 wherein the risk categories associated with each vulnerability are the same.

8. A computerized method according to claim 6 wherein each risk level set comprises a plurality of associated risk levels.

9. A computerized method according to claim 6 wherein each said risk rating is an integer (I) between 1 and 5, inclusively.

10. A computerized method according to claim 9 wherein a first one of said risk categories (C₁) corresponds to a level of resulting compromise to the computer system which could occur upon exploitation of the identified vulnerability, a second one of said risk categories (C₂) corresponds to a level of access to the computer system needed in order to exploit the identified vulnerability, a third one of said risk categories (C₃) corresponds to a degree of impact to the computer system which could occur upon exploitation of the identified vulnerability, a fourth one of said risk categories (C₄) corresponds to an availability of tools which could be employed to exploit the identified vulnerability, a fifth one of said risk categories (C₅) corresponds to a level of experience required in order to exploit the vulnerability, and a sixth one of said risk categories (C₅) corresponds to an availability of countermeasures for preventing exploitation of the vulnerability.

11. A computerized method according to claim 10 wherein said resultant risk value (RV) is calculated according to the formula:
RV={(I(C₁)+I(C₂)+I(C₃)+I(C₄)+I(C₅)/I(C₆)}

12. A computerized method according to claim 11 comprising assigning a respective weighting factor to each of said risk ratings, thereby to define a set of weighting factors, WF₁ through WFₙ, where “n” corresponds to the total number of risk categories, and wherein said resultant risk value (RV) is calculated according to the formula:
$$RV = \frac{\begin{matrix}{WF}_{1} \times I ( {C}_{1} ) + {WF}_{2} \times I ( {C}_{2} ) + \\ {WF}_{3} \times I ( {C}_{3} ) + {WF}_{4} \times I ( {C}_{4} ) + {WF}_{5} \times I ( {C}_{5} )\end{matrix}}{( {WF}_{6} \times I ( {C}_{6} )}$$

13. A computerized method according to claim 6 wherein said method is repeated for a plurality of different computer system environments.

14. A computer readable medium having computer executable instructions for performing a method comprising:
identifying a plurality of computer system vulnerabilities associated with a selected computer system environment;
identifying a risk category set associated with each identified vulnerability;
identifying a risk level set associated with each identified risk category in the risk category set;
with respect to each identified vulnerability:
assigning a risk rating for each associated risk category, wherein each risk rating has a risk value indicative of a level of risk for its associated risk category; and
computing a resultant risk value for the identified vulnerability based on its associated risk ratings, thereby to define a set of resultant risk values each indicative of a relative overall risk for the identified vulnerability; and
creating a prioritized listing of computer system vulnerabilities from the set of resultant risk values.

15. A computer readable medium according to claim 14 wherein each risk rating has a numerical risk value within a selected numerical range.

16. A computer readable medium according to claim 15 wherein said numerical range is an integer (I) between 1 and 5, inclusively.

17. A computer readable medium according to claim 14 wherein each risk category set includes a plurality or risk categories, there being a first one of said risk categories (C₁) corresponds to a level of resulting compromise to the computer system which could occur upon exploitation of the identified vulnerability, a second one of said risk categories (C₂) corresponds to a level of access to the computer system needed in order to exploit the identified vulnerability, a third one of said risk categories (C₃) corresponds to a degree of impact to the computer system which could occur upon exploitation of the identified vulnerability, a fourth one of said risk categories (C₄) corresponds to an availability of tools which could be employed to exploit the identified vulnerability, a fifth one of said risk categories (C₅) corresponds to a level of experience required in order to exploit the vulnerability, and a sixth one of said risk categories (C₅) corresponds to an availability of countermeasures for preventing exploitation of the vulnerability.

18. A computer readable medium according to claim 17 wherein the risk categories associated with each vulnerability are the same.

19. A computer readable medium according to claim 17 wherein said resultant risk value (RV) is calculated according to the formula:
RV={(I(C₁)+I(C₂)+I(C₃)+I(C₄)+I(C₅)/I(C₆)}

20. A computer readable medium according to claim 17 comprising assigning a respective weighting factor to each of said risk ratings, to define a set of weight factors WF₁ through WFₙ, where “n” corresponds to the total number of risk categories, and wherein said resultant risk value (RV) is calculated according to the formula:
$$RV = \frac{\begin{matrix}{WF}_{1} \times I ( {C}_{1} ) + {WF}_{2} \times I ( {C}_{2} ) + \\ {WF}_{3} \times I ( {C}_{3} ) + {WF}_{4} \times I ( {C}_{4} ) + {WF}_{5} \times I ( {C}_{5} )\end{matrix}}{( {WF}_{6} \times I ( {C}_{6} )}$$

21. A computer readable medium according to claim 14 wherein said computer executable instructions are capable of causing said method to be repeated for a plurality of different computer system environments.

22. A vulnerability rating system for assessing vulnerabilities associated with a selected computer system, comprising:
a storage device;
an output device; and
a processor programmed to:
assign a risk rating to each of a plurality of risk categories associated with each of a plurality of identified computer system vulnerabilities, each risk rating having a risk value indicative of a level of risk for its corresponding risk category;
generate a set of resultant risk values for the computer system by computing a resultant risk value for each identified vulnerability based on the vulnerability's associated risk ratings, each resultant risk value indicative of a relative overall risk for its associated vulnerability;
arrange the set of resultant risk values into a prioritized listing that is stored on said storage device; and
control said output device to display output corresponding to said prioritized listing.

23. A vulnerability rating system according to claim 22 wherein each risk rating has a numerical risk value within a selected numerical range.

24. A vulnerability rating system according to claim 22 wherein the risk categories associated with each vulnerability are the same.

25. A vulnerability rating system according to claim 22 wherein a first one of said risk categories (C₁) corresponds to a level of resulting compromise to the computer system which could occur upon exploitation of the identified vulnerability, a second one of said risk categories (C₂) corresponds to a level of access to the computer system needed in order to exploit the identified vulnerability, a third one of said risk categories (C₃) corresponds to a degree of impact to the computer system which could occur upon exploitation of the identified vulnerability, a fourth one of said risk categories (C₄) corresponds to an availability of tools which could be employed to exploit the identified vulnerability, a fifth one of said risk categories (C₅) corresponds to a level of experience required in order to exploit the vulnerability, and a sixth one of said risk categories (C₅) corresponds to an availability of countermeasures for preventing exploitation of the vulnerability.

26. A vulnerability rating system according to claim 25 wherein each respective resultant risk value (RV) is calculated according to the formula:
RV={(I(C₁)+I(C₂)+I(C₃)+I(C₄)+I(C₅)/I(C₆)}

27. A vulnerability rating system according to claim 26 comprising assigning a respective weighting factor to each of said risk ratings, to define a set of weight factors WF₁ through WFₙ, where “n” corresponds to the total number of risk categories, and wherein each respective resultant risk value (RV) is calculated according to the formula:
$$RV = \frac{\begin{matrix}{WF}_{1} \times I ( {C}_{1} ) + {WF}_{2} \times I ( {C}_{2} ) + \\ {WF}_{3} \times I ( {C}_{3} ) + {WF}_{4} \times I ( {C}_{4} ) + {WF}_{5} \times I ( {C}_{5} )\end{matrix}}{( {WF}_{6} \times I ( {C}_{6} )}$$

28. A vulnerability rating system for assessing vulnerabilities associated with a selected computer system environment, comprising:
storage means;
input means;
output means; and
processing means for:
identifying a plurality of computer system vulnerabilities associated with each of a plurality of different computer system environments, thereby to define associated sets of vulnerabilities;
causing the associated set of vulnerabilities to be stored on said storage means;
with respect to each of said computer system environments, and for each set of vulnerabilities associated therewith:
identifying an associated set of risk categories;
causing the associated set of risk categories to be stored on said storage means;
identifying at least one risk level associated with each identified risk category, thereby to define an associated risk level set;
causing the associated risk level set to be stored on the storage means;
receiving input from said input means corresponding to a risk rating being assigned for each of said risk categories, each risk rating having a risk value indicative of a level of risk for its corresponding risk category; and
computing a resultant risk value (RV) based on said input, thereby to generate a set of resultant risk values each indicative of a relative overall risk for the identified vulnerability; and
creating a vulnerability listing having a selected organization based on the set of resultant risk values.

29. A vulnerability rating system according to claim 28 wherein each said risk rating is an integer between 1 and 5, inclusively.

30. A vulnerability rating system according to claim 28 wherein the risk categories associated with each vulnerability associated with a selected computer system environment are the same.

31. A vulnerability rating system according to claim 28 wherein each risk level set comprises a plurality of associated risk factors.

32. A vulnerability rating system according to claim 28 wherein a first one of said risk categories (C₁) corresponds to a level of resulting compromise to the computer system which could occur upon exploitation of the identified vulnerability, a second one of said risk categories (C₂) corresponds to a level of access to the computer system needed in order to exploit the identified vulnerability, a third one of said risk categories (C₃) corresponds to a degree of impact to the computer system which could occur upon exploitation of the identified vulnerability, a fourth one of said risk categories (C₄) corresponds to an availability of tools which could be employed to exploit the identified vulnerability, a fifth one of said risk categories (C₅) corresponds to a level of experience required in order to exploit the vulnerability, and a sixth one of said risk categories (C₅) corresponds to an availability of countermeasures for preventing exploitation of the vulnerability.

33. A vulnerability rating system according to claim 32 wherein said resultant risk value (RV) is calculated according to the formula:
RV={(I(C₁)+I(C₂)+I(C₃)+I(C₄)+I(C₅)/I(C₆)}

34. A vulnerability rating system according to claim 32 comprising assigning a respective weighting factor to each of said risk ratings, to define a set of weight factors WF₁ through WFₙ, where “n” corresponds to the total number of risk categories, and wherein said resultant risk value (RV) is calculated according to the formula:
$$RV = \frac{\begin{matrix}{WF}_{1} \times I ( {C}_{1} ) + {WF}_{2} \times I ( {C}_{2} ) + \\ {WF}_{3} \times I ( {C}_{3} ) + {WF}_{4} \times I ( {C}_{4} ) + {WF}_{5} \times I ( {C}_{5} )\end{matrix}}{( {WF}_{6} \times I ( {C}_{6} )}$$
